(19) United States
(12) Patent Application Publication
(10) Pub. No.: US 2003/0113446 A1
(43) Pub. Date: Jun. 19, 2003

(54) Method for making dielectric ceramic material powder and dielectric ceramic material powder prepared thereby

(76) Inventors: Takashi Hasegawa, Omihachiman-shi (JP); Yasunari Nakamura, Shiga-ken (JP); Masami Yabuuchi, Yokaichi-shi (JP)

Correspondence Address: DICKSTEIN SHAPIRO MORIN & OSHINSKY LLP, Edward A, Meilman, 41st Floor, 1177 Avenue of the Americas, New York, NY, 10036-2714, US

(21) Appl. No.: 10/300,587

(22) Filed: Nov. 21, 2002

(30) Foreign Application Priority Data
Dec. 10, 2001 (JP) 2001-375400

(51) Int. Cl. B05D 7/00; B05D 3/02

(52) U.S. Cl. 427/212; 427/372.2

(57) ABSTRACT

A method for making a dielectric ceramic material powder containing a basic component powder including particles of a basic component for making a dielectric ceramic, a first additive component and a second additive component is provided. The first additive component has an effect of preventing the second additive component from forming a solid solution with the basic component powder. The method includes the steps of diffusing the first additive component into a surface region of each particle of the basic component powder, and adding the second additive component to the resulting basic component powder. After the dielectric ceramic material is sintered, each of the particles of the sintered compact can reliably have a core-shell structure that includes a core containing no second additive component and a shell containing diffused second additive component.

### BACKGROUND OF THE INVENTION

1. Field of the Invention

The present invention relates to a method for making a dielectric ceramic material powder and to a dielectric ceramic material powder prepared by the method. The present invention is particularly directed to an improvement that simplifies the control of the characteristics of a dielectric ceramic made from the dielectric ceramic material powder.

2. Description of the Related Art

Composite ceramic capacitors have dielectric ceramic layers between opposing internal electrodes. The dielectric ceramic layers are generally composed of dielectric ceramics that can provide capacitors with superior temperature stability in capacitance, such as those with the B characteristic according to Japanese Industrial Standards (JIS) or with the X7R characteristic according to Electronics Industries Association (EIA) standards.

Dielectric ceramics having superior temperature characteristics are generally made from a dielectric ceramic material powder containing a powder of a basic component, such as barium titanate, and additive components such as rare earth elements. When this type of dielectric ceramic material powder is baked to make a sintered compact, the individual particles that constitute the sintered compact, i.e., the dielectric ceramic, have a core that includes no diffused additive components and a shell that contains diffused additive components (i.e., a core-shell structure). The core-shell structure is known to enhance the temperature characteristics.

In order to ensure the formation of the core-shell structure described above, a substance that enhances the temperature stability of the capacitor and diffuses only in the surface regions of the basic component particles without forming a solid solution with the basic component is selected as an additive component, and this substance is added to the basic component powder with other additive components for accelerating sintering, for example. The resulting mixture is blended by a wet process to prepare a dielectric ceramic material powder.

In order to miniaturize and increase the capacity of monolithic ceramic capacitors, the thickness of ceramic dielectric layers should be reduced. In order to reduce the thickness of the dielectric ceramic layers, the dielectric ceramic material powder must be refined. Currently, dielectric ceramic material powders constituted from fine particles having an average particle diameter of 0.3 to 0.5 μm measured by scanning electron microscopy are used in practice. Moreover, in order to reduce the thickness of the dielectric ceramic layers, the composition of the dielectric ceramic material powders must be highly homogeneous.

In a conventional dielectric ceramic material powder, however, the particles of the additive components are usually coarser than those of the basic component powder. As a result, the composition of the dielectric ceramic material powder becomes heterogeneous. With such a heterogeneous composition, it is difficult to reduce the thickness of the dielectric ceramic layers.

To overcome the above-described weaknesses, a method whereby an additive component powder is pulverized in advance before being added to a basic component powder, a method whereby an additive component is chemically deposited on the surfaces of basic component particles, and a method whereby basic component particles are chemically coated with additive components have been developed. By these methods, a dielectric ceramic material powder having a homogeneous composition, which can make highly reliable monolithic ceramic capacitors with thin dielectric ceramic layers, can be prepared.

When the homogeneity of the composition of the dielectric ceramic material powder is enhanced according to these methods, however, the reactivity of the additive component with the basic component is also enhanced. As a result, the additive component excessively dissolves into the basic component powder to form a solid solution, thereby failing to obtain the core-shell structure. The resulting capacitor then has a degraded temperature stability, which is a problem.

### SUMMARY OF THE INVENTION

An object of the present invention is to provide a dielectric ceramic material powder which can overcome the above-described problem. Another object of the present invention is to provide a dielectric ceramic material powder prepared by this method.

The first aspect of the present invention provides a method for making a dielectric ceramic material powder comprising a basic component powder comprising particles of a basic component for making a dielectric ceramic, a first additive component, and a second additive component, the first additive component having an effect of preventing the second additive component from forming a solid solution with the basic component powder. The method includes the steps of diffusing the first additive component into a surface region of each particle of the basic component powder; and adding the second additive component to the resulting basic component powder.

According to the above method, the first additive component prevents the second additive component from forming a solid solution with the basic composition powder when the dielectric ceramic material powder is baked to form a sintered compact. As a result, each of the particles of the sintered compact can more reliably have a core-shell structure including a core having no second additive component diffused therein and a shell containing the diffused second additive component.

Preferably, the second additive component is added to adjust the characteristics of the dielectric ceramic. An example of the second additive component is a substance that can improve the temperature stability of capacitance so as to form a sintered compact which can provide excellent temperature stability of capacitance.

Moreover, according to the above-described aspect of the invention, the diffusion of the second additive component during sintering the dielectric ceramic material powder can be easily controlled. As a result, the uniformity in characteristics of the resulting sintered compacts can be enhanced.

Furthermore, according to the above-described aspect of the invention, sintered compacts having the core-shell structure can be reliably made even when the basic component powder is refined or when a highly homogeneous second additive component is added to the basic component powder. Thus, when monolithic ceramic capacitors are manufactured from the dielectric ceramic material powder of the present invention, the thickness of the dielectric ceramic layers can be reduced without problems, and miniaturized high-capacitance monolithic ceramic capacitors can be readily manufactured.

More preferably, the basic component is a substance represented by ABO₃ wherein A is barium that may partially be replaced with at least one of strontium, calcium and magnesium, and B is titanium that may partially be replaced with at least one of zirconium, tin, niobium and vanadium. The first additive component may contain at least one of yttrium and lanthanoids of atomic number 57 to 71, and the second additive component may contain at least one of magnesium, calcium, strontium, barium, manganese, silicon and boron.

Preferably, the first additive component is diffused into the surface regions of the particles of the basic component powder according to the following process.

The step of diffusing the first additive component into the basic component powder may include the substeps of dissolving an aqueous salt of the first additive component in a slurry prepared by suspending the basic component powder in water, depositing the first additive component on the surface of each particle of the basic component powder by sedimentation or evaporation to dryness, and heating the resulting basic component powder so as to allow the first additive component to diffuse into the surface regions of the particles of the basic component powder.

Alternatively, the step of diffusing the first additive component into the basic component powder may include dissolving an aqueous sol of the first additive component in a slurry prepared by suspending the basic component powder in water, allowing the first additive component to precipitate on the surface of the particles of the basic component powder by dehydration or evaporation to dryness, and heating the resulting basic component powder so as to allow the first additive component to diffuse into the surface region of the particles of the basic component powder.

Alternatively, the step of diffusing the first additive component into the basic component powder may include dissolving a salt of the first additive component in a slurry prepared by suspending the basic component powder in an organic solvent, removing the organic solvent so as to allow the first additive component to deposit on the surface of each particle of the basic component powder, and heating the resulting basic component powder so as to allow the first additive component to diffuse into the surface regions of the particles of the basic component powder.

According to any one of the above-described steps, the first additive component can be uniformly diffused in a thin layer at the surface regions of the particles of the basic component powder. Thus, the first additive component can effectively prevent the second additive component from forming a solid solution with the basic component powder.

Preferably, the second additive component is diffused into the resulting basic component powder according to the following process.

The second additive component may be used by dissolving an aqueous salt of the second additive component in a slurry prepared by suspending the basic component powder in water and allowing the second additive component to deposit on the surfaces of the particles of the basic component powder by sedimentation or evaporation to dryness.

Alternatively, adding the second additive component may include dissolving an aqueous sol of the second additive component in a slurry prepared by suspending the basic component powder in water and allowing the second additive component to deposit on the surfaces of the particles of the basic component powder by dehydration or evaporation to dryness.

Alternatively, adding the second additive component may include dissolving a salt of the second additive component in a slurry prepared by suspending the basic component powder in an organic solvent and allowing the second additive component to deposit on the surfaces of the particles of the basic component powder by removing the organic solvent.

According to any one of the above-described steps, the second additive component can be uniformly distributed over the surface of the particles of the basic component powder. Accordingly, the uniformity in the composition of the resulting dielectric ceramic material powder can be further enhanced.

Another aspect of the present invention provides a dielectric ceramic material powder prepared by the methods described above.

### BRIEF DESCRIPTION OF THE DRAWING

FIG. 1 is a cross-sectional view showing a monolithic ceramic capacitor 1 made using a dielectric ceramic material powder of the present invention.

### DESCRIPTION OF THE PREFERRED EMBODIMENTS

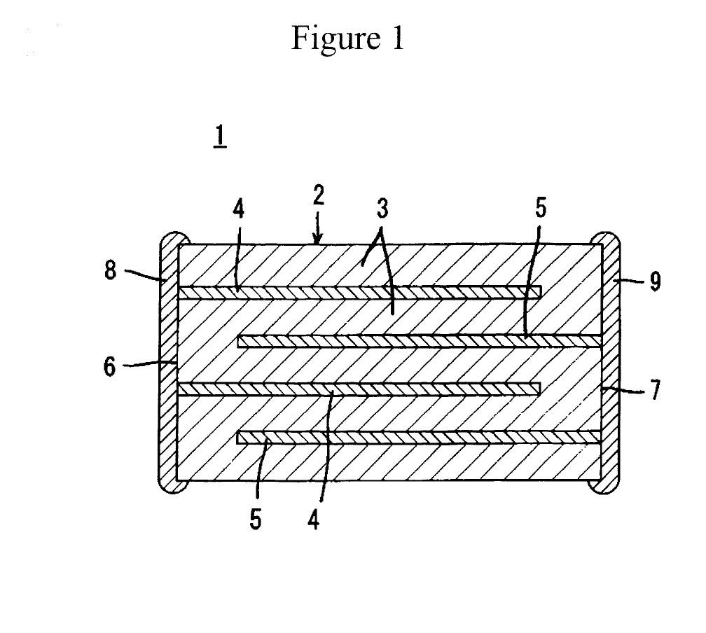

FIG. 1 is a cross-sectional view illustrating a monolithic ceramic capacitor 1 made using a dielectric ceramic material powder of the present invention.

The monolithic ceramic capacitor 1 includes a composite 2 having side faces 6 and 7. The composite 2 includes dielectric ceramic layers 3, internal electrodes 4 and internal electrodes 5. Each of the internal electrodes 4 and 5 extends along the interface between two dielectric ceramic layers. One end of each internal electrode 4 is exposed at the side face 6 and one end of each internal electrode 5 is exposed at the side face 7. The internal electrodes 4 and the internal electrodes 5 are alternately arranged inside the composite 2.

An external electrode 8 is formed on the side face 6 and an external electrode 9 is formed on the side face 7. The external electrodes 8 and 9 may be plated with nickel, copper or the like, if necessary. Furthermore, solder, tin or the like may be plated on the plated nickel, copper or the like.

The composite 2 of the monolithic ceramic capacitor 1 is prepared by sintering a precursor green composite. The precursor green composite includes green dielectric ceramic layers, which are the precursors of the dielectric ceramic layers 3, and precursors of the internal electrodes 4 and 5. The dielectric ceramic material powder of the present invention is the material of the green dielectric ceramic layers. By sintering the green dielectric ceramic layers, dielectric ceramic layers 3 composed of sintered dielectric ceramic are obtained.

A method for making the dielectric ceramic material powder will now be described.

First, a basic component powder of the dielectric ceramic is prepared. For example, the basic component is a substance represented by a general formula ABO₃, such as BaTiO₃, wherein A is barium that may partially be replaced with at least one of strontium (Sr), calcium (Ca) and magnesium (Mg), and B is titanium that may partially be replaced with at least one of zirconium (Zr), tin (Sn), niobium (Nb) and vanadium (V).

Next, a first additive component and a second additive component are prepared. The first additive component is a substance which prevents dissolution of the second additive component into the basic component powder. When the basic component is ABO₃, the first additive component preferably contains at least one of yttrium (Y) and lanthanoids of atomic number 57 to 71, and the second additive component preferably contains at least one of magnesium (Mg), calcium (Ca), strontium (Sr), barium (Ba), manganese (Mn), silicon (Si) and boron (B).

The second additive component adjusts the characteristics of the resulting dielectric ceramic. For example, the second additive component improves the temperature stability of the relative dielectric constant of the resulting dielectric ceramic.

Next, the first additive component is diffused into the surface regions of the basic component particles.

In particular, the basic component powder is suspended in water to prepare a slurry, and an aqueous salt of the first additive component is dissolved into the slurry so as to allow the first additive component to deposit on the surfaces of the basic component particles by sedimentation or evaporation to dryness. The basic component powder is then heated so as to allow the first additive component to diffuse into the surface region of each basic component particle.

Alternatively, an aqueous sol of the first additive component may be added to the slurry prepared by suspending the basic composition powder in water so as to prepare a mixture, and the mixture may be dehydrated or evaporated to dryness so as to allow the first additive component to precipitate at the surfaces of the basic component particles. The basic component powder may then be heated to allow the first additive component to diffuse into the surface region of each basic component particle.

Alternatively, the basic component powder may be suspended in an organic solvent to prepare a slurry, and a salt of the first additive component may be dissolved into the slurry. The salt may be any salt as long as it is dissolvable in the organic solvent. Subsequently, the organic solvent may be removed so as to allow the first additive component to deposit on the surface of the basic component particles, and the resulting basic component powder may be heated so as to allow the first additive component to diffuse into the surface region of each basic component particle.

Next, the second additive component is blended with the resulting basic component powder containing the first additive component diffused in the surface regions of the basic component particles.

In particular, the basic component powder is suspended in water to prepare a slurry, and an aqueous salt of the second additive component is dissolved into the slurry so as to allow the second additive component to deposit on the surfaces of the basic component particles by sedimentation or evaporation to dryness.

Alternatively, an aqueous sol of the second additive component may be added to the slurry prepared by suspending the basic composition powder in water to prepare a mixture, and the mixture may be dehydrated or evaporated to dryness so as to allow the second additive component to precipitate at the surfaces of the basic component particles.

Alternatively, the basic component powder may be suspended in an organic solvent to prepare a slurry, and a salt of the second additive component may be dissolved in the slurry. The organic solvent may then be removed so as to allow the second additive component to deposit on the surfaces of the basic component particles.

In the dielectric ceramic material powder of the present invention, each basic component particle contains the first additive component diffused into the surface region. Since the first additive component prevents the second additive component from forming a solid solution with the basic component, each of the particles after sintering can reliably have the core-shell structure including a core containing no second additive component and a shell containing the diffused second additive component.

Accordingly, when the dielectric ceramic material powder of the present invention is sintered to make dielectric ceramic layers 3 of the monolithic ceramic capacitor 1, the monolithic ceramic capacitor 1 can easily and stably achieve superior temperature characteristics such as the B characteristic defined by Japanese Industrial Standards (JIS) or the X7R characteristic defined by Electronics Industries Association (EIA) standards.

### EXAMPLES

Experiments were conducted to confirm the advantages of the above-described method for making the dielectric ceramic material powder of the present invention.

In the experiments, a barium titanate powder having an average particle diameter of 0.3 μm, as observed by scanning electron microscopy, was used as the basic component powder. The first additive component for preventing formation of a solid solution contained yttrium. The second additive component for adjusting the characteristics contained barium (Ba), magnesium (Mg), manganese (Mn) and silicon (Si). Samples of Example 1, which is within the scope of the present invention, and Comparative Examples 1 and 2, which are outside the scope of the present invention, were prepared using this basic component powder, the first additive component and the second additive component.

### Example 1

A slurry was prepared by suspending 150 g of a barium titanate powder in 500 ml of deionized water, and 5.0 g of yttrium nitrate (Y(NO₃)₃.6H₂O) was dissolved in the slurry.

The resulting slurry was dried by a rotary evaporator to obtain a powder. The powder was heated at 600° C. for 2 hours in a batch furnace to decompose the nitric acid residue and to diffuse yttrium into the surface region of each barium titanate particle. A cross-section of the particle was examined with a transmission electron microscope. The examination showed that yttrium was diffused in a thin layer in the surface region of each barium titanate particle.

Next, 120 g of the powder prepared as above was suspended in 400 ml of deionized water to prepare a slurry, and 1.3 g of barium nitrate (Ba(NO₃)₂), 1.2 g of magnesium nitrate (Mg(NO₃)₂.6H₂O) and 0.7 g of manganese nitrate (Mn(NO₃)₂.6H₂O) were dissolved in the slurry. Furthermore, 2.9 g of an aqueous SiO₂ sol (Si: 15 percent by weight) was added to the slurry, and the resulting slurry was thoroughly stirred. The slurry was then dried using a rotary evaporator to obtain a powder.

The powder was heated at 600° C. for 2 hours to decompose the nitric acid residue and to obtain a dielectric ceramic material powder of Example 1.

Next, 4 g of dioctyl phthalate and 72 g of a vehicle prepared by dissolving 20 percent by weight of polyvinyl butyral into a toluene/ethanol solvent having a 1/1 volume ratio were added to 100 g of the dielectric ceramic material powder of Example 1 to prepare a mixture. After the mixture was mixed with a ball mill, a ceramic green sheet having a thickness of 5 μm was formed using a gravure coater.

The ceramic green sheet was punched to have predetermined dimensions. An internal electrode was formed on the resulting green sheet using a nickel-containing conductive paste. A plurality of such ceramic green sheets were stacked and press-bonded to prepare a green composite. The green composite included 50 ceramic green sheets which were the precursors of the dielectric ceramic layers disposed between the internal electrodes.

The green composite was cut to obtain a green composite chip, i.e., a precursor of the composite of a monolithic ceramic capacitor. The green composite chip was baked at 1,240° C. for 2 hours in a reducing atmosphere so as to obtain a sintered compact.

External electrodes were formed on the side faces of the sintered compact to prepare a sample of a monolithic ceramic capacitor.

### Comparative Example 1

In COMPARATIVE EXAMPLE 1, all of the additive components including yttrium were simultaneously added to a barium titanate powder.

In particular, 120 g of barium titanate powder was suspended in 400 ml of deionized water to prepare a slurry, and 1.3 g of barium nitrate (Ba(NO₃)₂), 1.2 g of magnesium nitrate (Mg(NO₃)₂.6H₂O), 4.0 g of yttrium nitrate (Y(NO₃)₂.6H₂O) and 0.7 g of manganese nitrate (Mn(NO₃)₂.6H₂O) were dissolved in the slurry. Furthermore, 2.9 g of an aqueous SiO₂ sol (Si: 15 percent by weight) was added to the slurry, and the resulting slurry was thoroughly stirred.

The slurry was then dried using a rotary evaporator to obtain a powder. The powder was heated at 600° C. for 2 hours to decompose the nitric acid residue and to obtain a dielectric ceramic material powder of Comparative Example 1.

Using the dielectric ceramic material powder of Comparative Example 1, ceramic green sheets were prepared and a monolithic ceramic capacitor was made from the ceramic green sheets as in Example 1.

### Comparative Example 2

In COMPARATIVE EXAMPLE 2, additive components other than yttrium were dissolved in advance in a barium titanate powder to form a solid solution with the barium titanate powder.

In particular, 150 g of barium titanate powder was suspended in 500 ml of deionized water to prepare a slurry, and 1.7 g of barium nitrate (Ba(NO₃)₂), 1.6 g of magnesium nitrate (Mg(NO₃)₂.6H₂O) and 0.8 g of manganese nitrate (Mn(NO₃)₂.6H₂O) were dissolved in the slurry. Furthermore, 3.5 g of an aqueous SiO₂ Sol (Si: 15 percent by weight) was added to the slurry, and the resulting slurry was thoroughly stirred.

The slurry was then dried using a rotary evaporator to obtain a powder. The powder was heated at 600° C. for 2 hours in a batch furnace to decompose the nitric acid residue and to diffuse the additive components into the surface region of each barium titanate particle. A cross-section of the particle was examined with a transmission electron microscope. The examination showed that barium, magnesium and silicon existed on the surface of each barium titanate particle whereas the manganese was diffused into each barium titanate particle.

Next, 120 g of the above-described powder was suspended in 400 ml of deionized water to obtain a slurry, and 4.0 g of yttrium nitrate (Y(NO₃)₃.6H₂O) was dissolved in the slurry.

The resulting slurry was dried by a rotary evaporator to obtain a powder. The powder was heated at 600° C. for 2 hours in a batch furnace to decompose the nitric acid residue and to obtain a dielectric ceramic material powder of Comparative Example 2.

Using the dielectric ceramic material powder of Comparative Example 2, ceramic green sheets were prepared and a monolithic ceramic capacitor was made using the ceramic green sheets as in Example 1.

The dielectric constant (εr), dielectric loss (DF), and insulation resistance (log IR) of the monolithic ceramic capacitors of Example 1 and Comparative Example 1 and 2 were examined. To evaluate whether the X7R characteristic according to EIA standard was satisfied, the change in capacitance with temperature at −55° C. and at 125° C. was determined based on the capacitance at 25° C. The results are shown in Table 1.

TABLE 1

| | Dielectric | Dielectric | Dielectric | Change in capacitance | |
|---|---|---|---|---|---|
| | constant | loss | loss | with temperature (%) | |
| Sample No. | (ε r) | (DF)(%) | (DF)(%) | −55° C. | 125° C. |
| Example 1 | 2480 | 1.9 | 9.6 | 1.6 | 13.2 |
| Comparative | 2750 | 2.2 | 9.7 | 0.0 | 16.1 |
| Example 1 | | | | | |
| Comparative | 2920 | 2.7 | 9.8 | −2.3 | −17.7 |
| Example 2 | | | | | |

Table 1 shows that the change in capacitance with temperature of the monolithic ceramic capacitor prepared using the dielectric ceramic material powder of the present invention was within the range of 15% and thus satisfied the X7R characteristic of the EIA standards.

The monolithic ceramic capacitors of Comparative Examples 1 and 2 made using the dielectric ceramic material powder outside the scope of the present invention did not satisfy the X7R characteristic of the EIA standards.

In the above-described embodiments and examples, substances which improve the temperature stability of the capacitance were added as the second additive component. Alternatively, a substance which improves the insulation resistance or a substance which improves the sinterability may be added as the second additive component. Alternatively, a substance which has a function other than controlling the characteristics of the dielectric ceramic may be used.

What is claimed is:

1. A method for making a dielectric ceramic material powder comprising a basic component powder comprising particles of a basic component for making a dielectric ceramic, a first additive component, and a second additive component, the first additive component having an effect of preventing the second additive component from forming a solid solution with the basic component powder, the method comprising the steps of:
diffusing the first additive component into a surface region of each particle of the basic component powder; and
adding the second additive component to the resulting basic component powder.

2. The method according to claim 1, wherein the second additive component is a dielectric ceramic characteristic adjustment agent.

3. The method according to claim 2, wherein the basic component comprises ABO₃ wherein A is barium or barium in combination with at least one of strontium, calcium and magnesium, and B is titanium or titanium in combination with at least one of zirconium, tin, niobium and vanadium,
wherein the first additive component comprises at least one member of the group consisting of yttrium and lanthanoids of atomic number 57 to 71, and
wherein the second additive component comprises at least one member of the group consisting of magnesium, calcium, strontium, barium, manganese, silicon and boron.

4. The method according to claim 1, wherein the diffusing of the first additive component into the basic component powder comprises combining an aqueous salt or sol of the first additive component with a first slurry comprising the basic component powder in a first carrier, depositing the first additive component on the surface of each particle of the basic component powder by precipitation, sedimentation or evaporation to dryness, and heating the resulting basic component powder so as to allow the first additive component to diffuse into the surface regions of the particles of the basic component powder.

5. The method according to claim 4, wherein the diffusing of the first additive component into the basic component powder comprises dissolving an aqueous salt of the first additive component in a slurry comprising the basic component powder in water, depositing the first additive component on the surface of each particle of the basic component powder by sedimentation or evaporation to dryness, and heating the resulting basic component powder so as to allow the first additive component to diffuse into the surface regions of the particles of the basic component powder.

6. The method according to claim 4, wherein the diffusing of the first additive component into the basic component powder comprises dissolving an aqueous sol of the first additive component in a slurry comprising the basic component powder in water, allowing the first additive component to precipitate on the surface of the particles of the basic component powder by dehydration or evaporation to dryness, and heating the resulting basic component powder so as to allow the first additive component to diffuse into the surface region of the particles of the basic component powder.

7. The method according to claim 4, wherein the diffusing of the first additive component into the basic component powder comprises dissolving a salt of the first additive component in a slurry comprising the basic component powder in an organic solvent, removing the organic solvent so as to allow the first additive component to deposit on the surface of each particle of the basic component powder, and heating the resulting basic component powder so as to allow the first additive component to diffuse into the surface regions of the particles of the basic component powder.

8. The method according to claim 1, wherein the adding of the second additive component comprises combining a salt or sol of the second additive component with a second slurry comprising the first additive containing basic component powder in a second carrier and allowing the second additive component to deposit on the surfaces of the particles of the basic component powder by removal of the second carrier.

9. The method according to claim 8, wherein the adding of the second additive component comprises dissolving an aqueous salt of the second additive component in a slurry comprising the basic component powder in water and allowing the second additive component to deposit on the surfaces of the particles of the basic component powder by sedimentation or evaporation to dryness.

10. The method according to claim 8, wherein the adding of the second additive component comprises dissolving an aqueous sol of the second additive component in a slurry comprising the basic component powder in water and allowing the second additive component to deposit on the surfaces of the particles of the basic component powder by dehydration or evaporation to dryness.

11. The method according to claim 8, wherein the adding of the second additive component comprises dissolving a salt of the second additive component in a slurry comprising the basic component powder in an organic solvent and allowing the second additive component to deposit on the surfaces of the particles of the basic component powder by removing the organic solvent.

12. The method according to claim 2, wherein the diffusing of the first additive component into the basic component powder comprises dissolving a salt or aqueous sol of the first additive component in a first slurry comprising the basic component powder in a first carrier, allowing the first additive component to precipitate on the surface of the particles of the basic component powder by dehydration or evaporation to dryness, and heating the resulting basic component powder so as to allow the first additive component to diffuse into the surface region of the particles of the basic component powder.

13. The method according to claim 12, wherein the adding of the second additive component comprises combining a salt or sol of the second additive component with a second slurry comprising the first additive containing basic component powder in a second carrier and allowing the second additive component to deposit on the surfaces of the particles of the basic component powder by removal of the second carrier.

14. The method according to claim 1, wherein the diffusing of the first additive component into the basic component powder comprises dissolving a salt or aqueous sol of the first additive component in a first slurry comprising the basic component powder in a first carrier, allowing the first additive component to precipitate on the surface of the particles of the basic component powder by dehydration or evaporation to dryness, and heating the resulting basic component powder so as to allow the first additive component to diffuse into the surface region of the particles of the basic component powder.

15. The method according to claim 14, wherein the adding of the second additive component comprises combining a salt or sol of the second additive component with a second slurry comprising the first additive containing basic component powder in a second carrier and allowing the second additive component to deposit on the surfaces of the particles of the basic component powder by removal of the second carrier.

16. The method according to claim 1, wherein the adding of the second additive component comprises combining a salt or sol of the second additive component with a second slurry comprising the first additive containing basic component powder in a second carrier and allowing the second additive component to deposit on the surfaces of the particles of the basic component powder by removal of the second carrier.

17. A dielectric ceramic material powder prepared by the method according to claim 15.

18. A dielectric ceramic material powder prepared by the method according to claim 3.

19. A dielectric ceramic material powder prepared by the method according to claim 2.

20. A dielectric ceramic material powder prepared by the method according to claim 1.
